(19) United States
(12) Patent Application Publication
(10) Pub. No.: US 2017/0250477 A1
(43) Pub. Date: Aug. 31, 2017

(54) ELECTRICAL TERMINAL WITH SELF-CHECKING INSTALLATION CONFIRMATION FEATURE

(71) Applicant: GM GLOBAL TECHNOLOGY OPERATIONS LLC, Detroit, MI (US)

(72) Inventors: SCOTT B. DINICH, LONDON (CA); JOEL R. BREDDY, ONTARIO (CA)

(73) Assignee: GM GLOBAL TECHNOLOGY OPERATIONS LLC, Detroit, MI (US)

(21) Appl. No.: 15/053,698

(22) Filed: Feb. 25, 2016

(51) Int. Cl. H01R 4/30; H01R 43/16

(52) U.S. Cl. CPC H01R 4/304; H01R 43/16

(57) ABSTRACT

An electrical terminal, a corresponding electrical assembly, and a related installation method are disclosed herein. An exemplary embodiment of the electrical assembly includes an electrically conductive threaded mounting post, a threaded fastener that mates with the mounting post, and a terminal for an electrical conductor. The terminal has a deformable feature that compresses when the fastener is installed to clamp the terminal between a contact surface of the mounting post and the fastener. The deformable feature has mechanical properties and characteristics such that torque required to compress the deformable feature increases during installation of the fastener.

### TECHNICAL FIELD

Embodiments of the subject matter described herein relate generally to electrical connectors and terminals. More particularly, embodiments of the subject matter relate to an electrical terminal having an integrated feature that facilitates automated confirmation of proper installation of the electrical terminal.

### BACKGROUND

The prior art is replete with electrical connectors, conductive terminals, wire designs, and cable designs. An eyelet or spade terminal can be physically and electrically coupled to the end of conductive wire or cable, wherein the terminal is designed to mate with a conductive mounting post or similar feature. For example, a vehicle may have one or more threaded mounting posts that correspond to chassis ground (or to any designated voltage level). A threaded mounting post is shaped and sized to receive a conductive terminal and a threaded fastener, which is tightened overlying the terminal. When properly installed, the terminal remains clamped between a base/shoulder of the mounting post and the threaded fastener. The fastener is threaded onto the terminal to achieve a secure physical and electrical connection.

In accordance with a typical installation process, the amount of torque applied to the threaded fastener is measured as the fastener is tightened onto the threaded mounting post, and the automated tool is stopped when a threshold torque measurement is reached. There may be situations, however, when the threshold torque measurement is achieved even though the electrical terminal is not properly installed and secured to the mounting post. For example, if the threads of the fastener or the mounting post are stripped, then the threshold torque measurement can be reached prematurely. As another example, if the terminal is improperly placed onto the mounting post, or if the fastener is threaded onto the mounting post without installing the terminal first, then the threshold torque measurement can be reached when the fastener reaches the bottom of the mounting post.

Accordingly, it is desirable to have an electrical terminal design and a related installation methodology that addresses the situations mentioned above. In addition, it is desirable to have an electrical terminal design that facilitates an automated and self-checking installation process. Furthermore, other desirable features and characteristics will become apparent from the subsequent detailed description and the appended claims, taken in conjunction with the accompanying drawings and the foregoing technical field and background.

### BRIEF SUMMARY

Disclosed herein is a terminal for an electrical conductor. An exemplary embodiment of the terminal includes a primary base structure formed of an electrically conductive material, and a deformable feature extending above the primary base structure. The primary base structure includes a coupling feature to receive a mounting post. The deformable feature is compressible in response to installation of a fastener that clamps the terminal between a shoulder of the mounting post and the fastener. The deformable feature has mechanical properties and characteristics such that force required to compress the deformable feature varies as a function of height of the deformable feature.

Also disclosed herein is an electrical assembly. An exemplary embodiment of the electrical assembly includes an electrically conductive threaded mounting post having a contact surface, a threaded fastener that mates with the threaded mounting post, and a terminal for an electrical conductor. The terminal has a deformable feature that compresses when the threaded fastener is installed to clamp the terminal between the contact surface and the threaded fastener. The deformable feature has mechanical properties and characteristics such that torque required to compress the deformable feature increases during installation of the threaded fastener.

Also disclosed herein is a method of checking an installation of a terminal for an electrical conductor on an electrically conductive threaded mounting post having a contact surface for the terminal. An exemplary embodiment of the method involves coupling the terminal to the threaded mounting post, wherein the terminal has a deformable feature that compresses when a threaded fastener is installed to clamp the terminal between the contact surface and the threaded fastener, and wherein the deformable feature has mechanical properties and characteristics such that torque required to tighten the threaded fastener increases as the deformable feature compresses. The method continues by installing the threaded fastener onto the threaded mounting post and overlying the terminal, and by measuring, with a computer-based torque measurement tool, torque associated with installation of the threaded fastener onto the threaded mounting post until a final torque value is reached. The final torque value represents a tightened state of the fastener. The method continues by analyzing, with the computer-based torque measurement tool, the measured torque to confirm presence of the terminal between the threaded fastener and the contact surface.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a perspective view of a mounting post for an electrical terminal;

FIG. 2 is a side view of the mounting post shown in FIG. 1;

FIG. 3 is a side view of the mounting post shown in FIG. 1, with an electrical terminal secured thereto;

FIG. 4 is a plot of torque versus time associated with installing a conventional electrical terminal onto a mounting post;

FIGS. 5-8 are perspective views of an electrical terminal configured in accordance with various embodiments of the invention;

FIG. 9 is a plot of torque versus time associated with installing a deformable (compressible) electrical terminal onto a mounting post; and

FIG. 10 is a flow chart that illustrates an exemplary embodiment of a process for checking the installation of a deformable (compressible) electrical terminal.

### DETAILED DESCRIPTION

The following detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, brief summary or the following detailed description.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. When implemented in software or firmware, various elements of the systems described herein are essentially the code segments or instructions that perform the various tasks. In certain embodiments, the program or code segments are stored in a tangible processor-readable medium, which may include any medium that can store or transfer information. Examples of a non-transitory and processor-readable medium include an electronic circuit, a semiconductor memory device, a ROM, a flash memory, an erasable ROM (EROM), a floppy diskette, a CD-ROM, an optical disk, a hard disk, or the like.

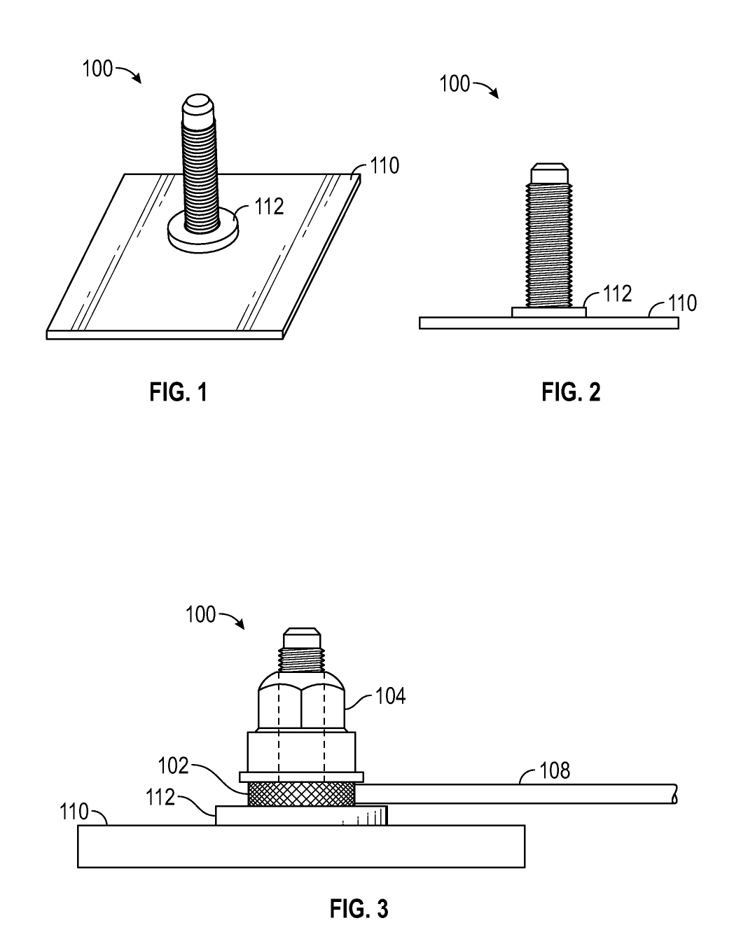

FIG. 1 is a perspective view of a mounting post 100 for an electrical terminal, and FIG. 2 is a side view of the mounting post 100. The mounting post 100 is threaded to mate with a threaded fastener such as a nut. FIG. 3 is a side view of the mounting post 100, with an electrical terminal 102 secured thereto. FIG. 3 also shows a threaded fastener 104, which is threaded onto the mounting post 100 and tightened to secure the electrical terminal 102 in position. The electrical terminal 102 is physically and electrically coupled to an electrical conductor 106, which may be a solid single wire, a multi-stranded wire, a cable assembly, a ribbon, a conductive trace, or the like.

The mounting post 100 extends above a support structure 110, which may be an electrically conductive panel, bar, bus, frame, or the like. In certain non-limiting embodiments, the support structure 110 is an electrically conductive part of a vehicle having a chassis ground voltage potential. The primary section of the mounting post 100 is threaded to mate with and receive the fastener 104. A lower section of the mounting post 100 includes an electrically conductive shoulder 112, base, or contact surface that is shaped, sized, and configured to provide a good platform to receive the electrical terminal 102. In certain embodiments, the mounting post 100 is formed from an electrically conductive material, such as steel.

For the exemplary embodiment shown throughout the figures, the electrical terminal 102 includes an eyelet structure having a hole that receives the mounting post 100. In alternative embodiments, the electrical terminal 102 can include a spade structure, a prong structure, a U-shaped structure, a C-shaped structure, or the like, wherein the structure is shaped and sized to accommodate the mounting post 100.

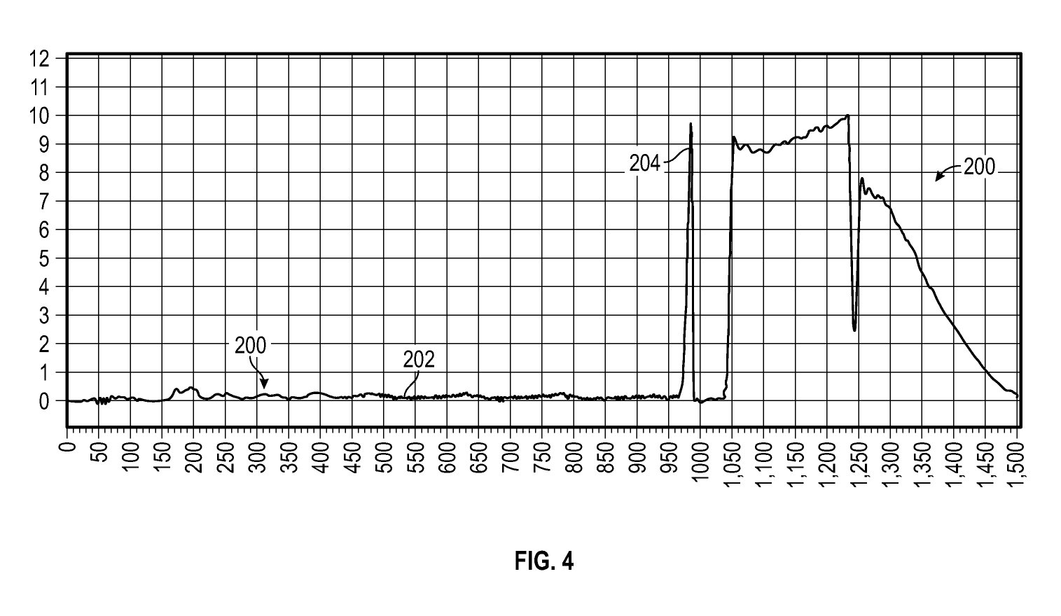

FIG. 4 is a plot 200 of torque versus time associated with installing a conventional electrical terminal onto a mounting post, wherein the conventional electrical terminal has a relatively flat primary base structure that is designed to be clamped between a shoulder or contact surface of the mounting post and the threaded fastener (as depicted in FIG. 3). The vertical axis represents measured torque in newton-meters (N-m), and the horizontal axis represents time in milliseconds. The torque values can be obtained from a torque measurement tool or system that is coupled to the threaded fastener while the fastener is being installed onto the mounting post. In certain embodiments, the torque measurement tool includes the socket that mates with the threaded fastener, and it is controlled to drive the socket at the desired speed. The torque data obtained by the torque measurement tool can be processed and displayed or output in any format, including the plot 200 shown in FIG. 4.

The somewhat flat initial portion 202 of the plot 200 corresponds to the period of time before the threaded fastener experiences any clamping resistance. In other words, the threaded fastener is freely spinning with little to no resistance during the initial portion 202 of the plot 200. The abrupt spike 204 in the plot 200 corresponds to the very brief period of time during which the threaded fastener clamps the electrical terminal against the shoulder or contact surface of the mounting post. Notably, the measured torque quickly rises to almost 10 N-m at this point. Thereafter, the plot 200 exhibits a dip before rising again; this behavior is caused by a change in the rotational speed of the tool. Although not always required, the rotational speed of the tool can be reduced after the measured torque reaches a threshold value, such that the desired final torque value (which is about 10 N-m for this example) can be reached in a gradual and accurate manner.

The plot 200 demonstrates why it can be difficult to detect an improperly installed electrical terminal in certain situations. For example, if the threads of the mounting post and/or the fastener are stripped or are otherwise compromised, then the measured torque can rapidly increase or spike up (as shown in FIG. 4) if rotation of the fastener is inhibited due to the stripped threads. As another example, if the fastener is installed onto the mounting post in the absence of the electrical terminal, then the measured torque can rapidly increase or spike up when the fastener reaches the bottom of the mounting post. Both of these scenarios can result in a quickly escalating torque measurement that exhibits the same characteristics as a properly installed electrical terminal.

An electrical terminal of the type described below includes one or more deformable, compressible, and/or crushable features that allow a torque measurement tool to automatically and reliably detect whether or not the electrical terminal is properly installed and clamped onto the mounting post. In certain embodiments, the deformable feature of the terminal is destructively deformed in response to installing the threaded fastener onto the mounting post. The deformable feature(s) result in measured installation torque values that vary in a detectable and predictable manner as the threaded fastener is tightened atop the terminal. The torque profile of a properly installed terminal is detectably different than the torque profile of an improperly installed terminal. Accordingly, the torque data obtained by the tool can be easily analyzed to determine and report the installation status of the terminal.

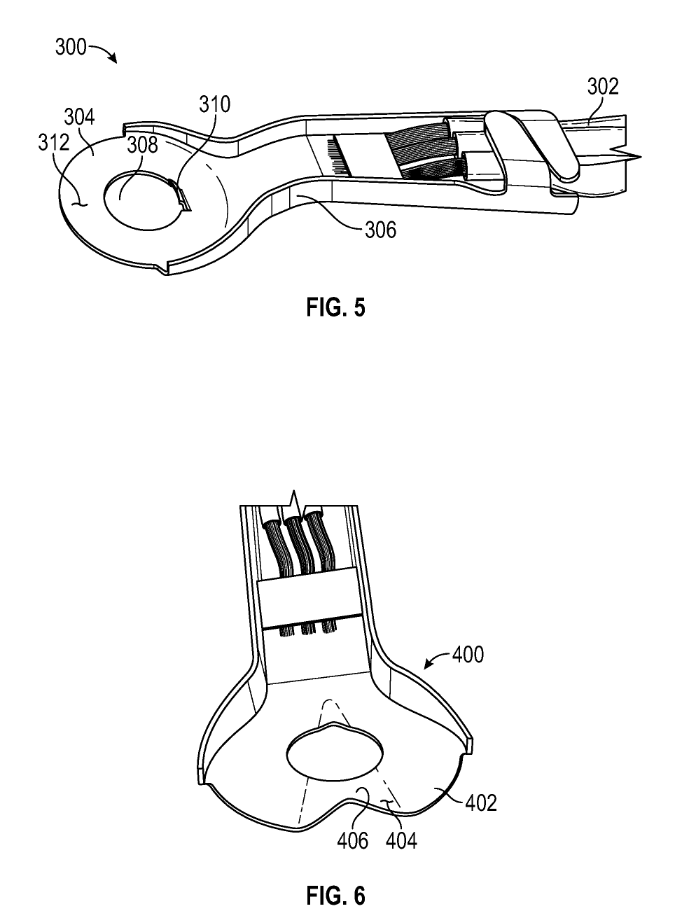

FIG. 5 is a perspective view of an exemplary embodiment of an electrical terminal 300. This particular embodiment of the terminal 300 can be physically and electrically connected to an electrical conductor 302. Although not required, the terminal 300 can be fabricated as a one-piece component from an electrically conductive material such as copper, aluminum, or the like. The terminal 300 shown in FIG. 5 generally includes a primary base structure 304, a neck region 306 extending from the primary base structure 304, a coupling feature 308 configured to receive the mounting post, and a deformable feature 310 extending above the primary base structure 304. The neck region 306 accommodates the electrical conductor 302 and serves as the physical and electrical coupling structure for the conductor 302.

The primary base structure 304 includes a major contact surface 312 that is relatively flat and straight. In this regard, the primary base structure 304 resembles a flat donut-shaped washer or an eyelet structure. The coupling feature 308 for this embodiment is realized as a hole formed in the primary base structure 304. The hole is shaped and sized in accordance with the mounting post to which the electrical terminal 300 is coupled.

The deformable feature 310 can be realized as a tab or a flap that is integrally formed in the primary base structure 304. As shown in FIG. 5, the deformable feature 310 rises above the major contact surface 312 and extends upward at an initial angle. Although the terminal 300 illustrated in FIG. 5 has only one deformable feature 310, alternative embodiments can include a plurality of deformable features 310 if so desired. The deformable feature 310 is shaped, sized, and otherwise configured such that a certain amount of compressive force is required to deflect, compress, and deform the feature 310 during proper installation of the threaded fastener. In other words, the deformable feature 310 is designed to be bent downward by the threaded fastener as the fastener is tightened onto the threaded mounting post.

The deformable feature 310 is compressible in response to the installation of the fastener, which clamps the terminal 300 between the shoulder or contact surface of the mounting post and the fastener. More specifically, the deformable feature 310 is designed to have certain predictable mechanical properties and characteristics such that the amount of force (or torque) required to compress the deformable feature 310 varies as a function of the height of the deformable feature 310, relative to the major contact surface 312. In certain embodiments, the amount of force or torque required to compress the deformable feature 310 increases as the height of the deformable feature 310 decreases. Accordingly, the force or torque required to compress the deformable feature can be applied by threading the fastener onto the mounting post. Moreover, the amount of force/torque applied and measured by the installation tool increases as the threaded fastener crushes the deformable feature, until a final threshold torque value has been reached. For this reason, the output of the torque measurement tool indicates whether or not the terminal is present between the contact surface of the mounting post and the fastener during installation of the fastener onto the mounting post.

FIG. 6 is a perspective view of another exemplary embodiment of an electrical terminal 400 having deformable properties. The terminal 400 is similar in some respects to the terminal 300 described above, and common features and characteristics will not be redundantly described here. This particular embodiment of the terminal 400 utilizes a bendable, compressible, or otherwise deformable element of the primary base structure 402. As shown in FIG. 6, the primary base structure 402 can be bent or slightly folded at one or more locations, which results in a primary contact surface 404 that is contoured to exhibit the desired deformable characteristics. Downward force applied to the primary contact surface 404 by the threaded fastener causes the base structure 402 to flatten, which in turn results in the measurable torque characteristic that indicates the presence of a properly installed terminal 400. Although the terminal 400 depicted in FIG. 6 includes only one “inverted v” shaped bend 406, it should be appreciated that an embodiment of the terminal 400 can include any number of bends, raised contours, or “three dimensional” features if so desired.

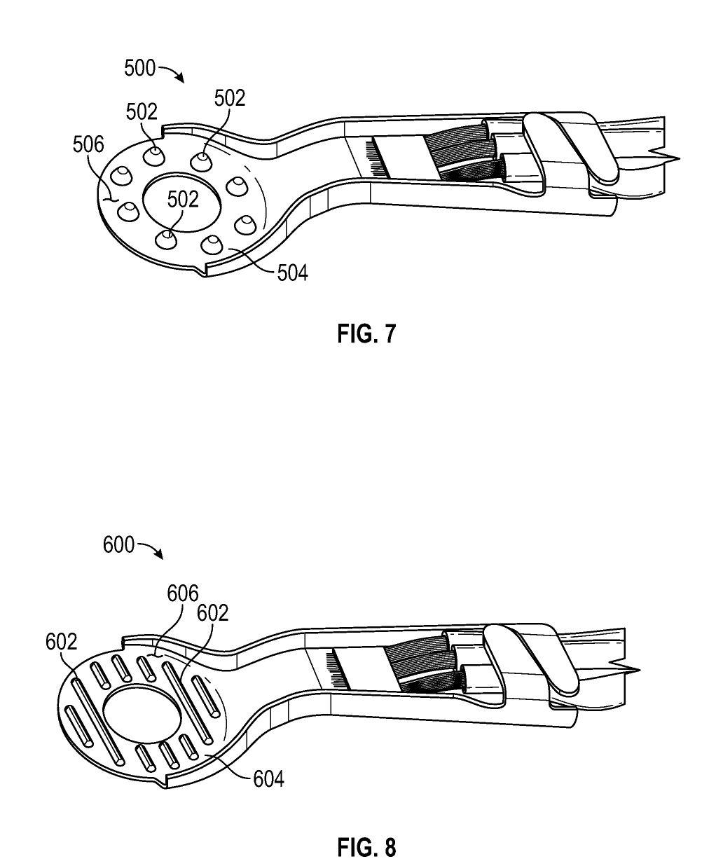

FIG. 7 is a perspective view of another exemplary embodiment of an electrical terminal 500 having deformable properties. The terminal 500 is similar in some respects to the terminal 300 described above, and common features and characteristics will not be redundantly described here. This particular embodiment of the terminal 500 utilizes deformable texturing 502 that is integrally formed in (or affixed to) the primary base structure 504. The deformable texturing 502 can be realized as one or more raised bumps or lumps that extend above the primary contact surface 506 of the terminal 500. Downward force applied to the terminal 500 by the threaded fastener causes the texturing 502 to flatten, which in turn results in the measurable torque characteristic that indicates the presence of a properly installed terminal 500.

FIG. 8 is a perspective view of another exemplary embodiment of an electrical terminal 600 having deformable properties. The terminal 600 is similar in some respects to the terminal 300 described above, and common features and characteristics will not be redundantly described here. This particular embodiment of the terminal 600 utilizes deformable texturing 602 that is integrally formed in (or affixed to) the primary base structure 604. In this regard, the terminal 600 is similar to the terminal 500 described above. The deformable texturing 602, however, is realized as one or more raised ridges, bars, or other elements that extend above the primary contact surface 606 of the terminal 600. Downward force applied to the terminal 600 by the threaded fastener causes the texturing 602 to flatten, which in turn results in the measurable torque characteristic that indicates the presence of a properly installed terminal 600.

It should be appreciated that other deformable or compressible features can be implemented in an electrical terminal, and that the variations described in detail herein are not exhaustive or limiting. For example, the electrical terminal can be fabricated with a relatively flat base structure that can be compressed by the fastener. This behavior can be achieved using multiple layers of different materials, a composite structure, or the like. As another implementation, the base structure of the electrical terminal can be manufactured with a “waffle” structure having support members with adjacent cavities. As yet another example, the base structure of the electrical terminal can be fabricated with a wavy or curved profile that bends up and down relative to the direction of force as applied by the fastener.

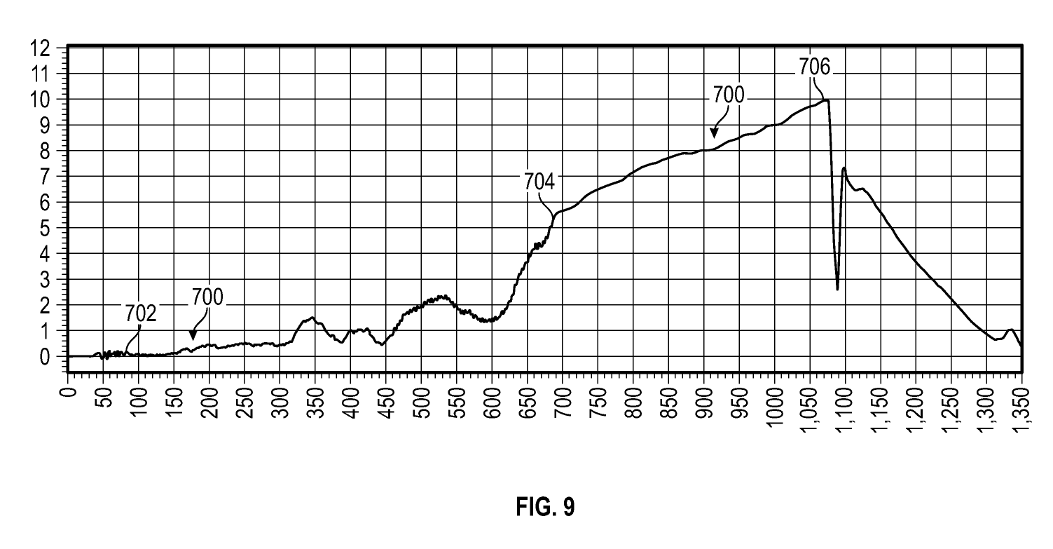

FIG. 9 is a plot 700 of torque versus time associated with installing a deformable (compressible) electrical terminal onto a mounting post, wherein the electrical terminal has the compressible properties and characteristics described above. The vertical axis represents measured torque in newton-meters (N-m), and the horizontal axis represents time in milliseconds. The torque data can be obtained by a torque measurement tool during installation of the terminal.

The somewhat flat initial portion 702 of the plot 700 corresponds to the period of time before the threaded fastener makes contact with the protruding deformable feature(s) of the terminal. In other words, the threaded fastener is freely spinning with little to no resistance during the initial portion 702 of the plot 700. Thereafter, the measured torque increases over time as the fastener continues to be threaded onto the mounting post. The sloped region 704 of the plot 700 is discernable from about 300 milliseconds to about 1050 milliseconds. Notably, the measured torque rises in a somewhat gradual and consistent manner until it reaches the endpoint 706 of about 10 N-m. In contrast to the spike 204 shown in FIG. 4, the increasing torque profile of the plot 700 is easily distinguishable from the measured torque profile that results from a missing terminal or a stripped mounting post that inhibits rotation of the fastener. Accordingly, the output of the torque measurement tool can be analyzed to confirm whether or not a deformable fastener has been properly installed, based on the measured torque profile. More specifically, if the measured torque profile does not exhibit an increasing trend toward a predefined final torque value, then the tool can generate an alarm, a warning message, or the like. In accordance with some embodiments, the tool can display the plot of the measured torque such that a human operator can quickly and easily confirm the integrity of the installation procedure.

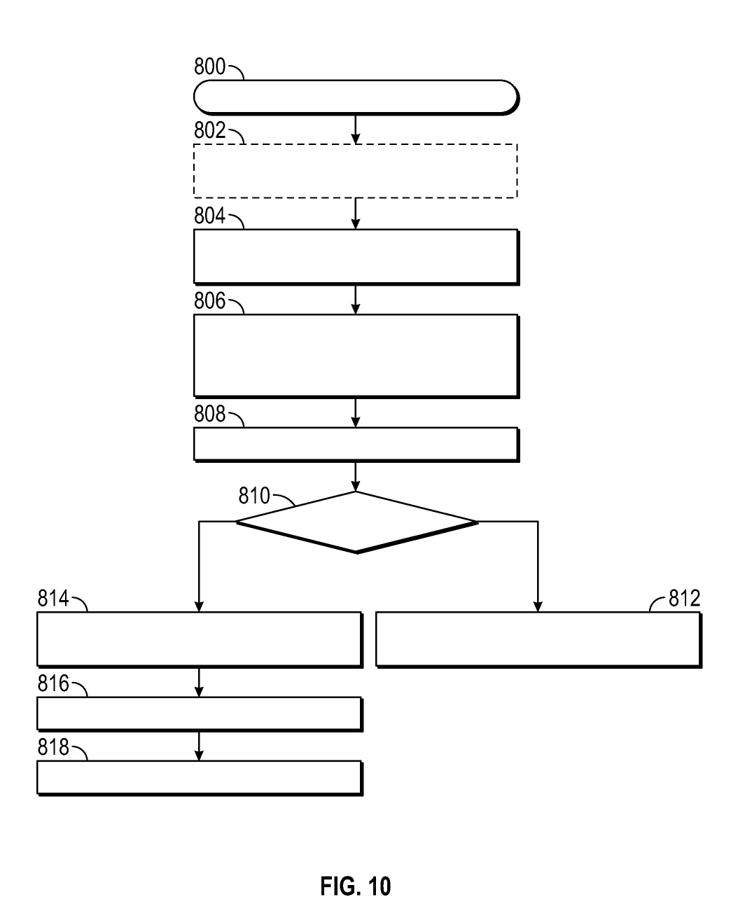

FIG. 10 is a flow chart that illustrates an exemplary embodiment of a process 800 for checking the installation of a deformable (compressible) electrical terminal. The process 800 also represents an exemplary embodiment of a method of mechanically and electrically connecting a terminal for an electrical conductor to an electrically conductive threaded mounting post having a contact surface for the terminal. The various tasks performed in connection with the process 800 may be performed by software, hardware, firmware, or any combination thereof. For illustrative purposes, the following description of the process 800 may refer to elements mentioned above in connection with FIGS. 1-9. It should be appreciated that the process 800 may include any number of additional or alternative tasks, the tasks shown in FIG. 10 need not be performed in the illustrated order, and the process 800 may be incorporated into a more comprehensive procedure or process having additional functionality not described in detail herein. Moreover, one or more of the tasks shown in FIG. 10 could be omitted from an embodiment of the process 800 as long as the intended overall functionality remains intact.

The process 800 may begin by coupling a deformable electrical terminal to a threaded mounting post (task 802), wherein the terminal has the mechanical properties and characteristics described above. FIG. 10 depicts task 802 in dashed lines because the process 800 can be performed whether or not the terminal is actually placed onto the mounting post. Indeed, the process 800 is designed to detect a condition that is indicative of a missing terminal. After coupling the terminal to the mounting post, the process 800 continues by installing a threaded fastener onto the threaded end of the mounting post, such that the fastener is overlying the terminal (task 804). Task 804 can be performed by hand, or by the fastening and torque measuring tool. After initially installing the fastener onto the mounting post, the fastener is rotated to tighten it onto the terminal and to clamp the terminal between the contact surface of the mounting post and the fastener. A computer-based torque measurement tool can be operated to rotate the fastener and to measure the torque that is associated with the installation of the fastener (task 806). Task 806 is performed in an ongoing manner until a final torque value is reached. The final torque value represents the desired tightened and fully installed state of the terminal on the mounting post. For the example shown in FIG. 9, the final torque value is set at 10 N-m, although other values can be selected to suit the needs of the particular application.

The torque measurement tool and/or a suitably configured computer-based system analyzes the measured torque data to confirm whether or not the terminal was properly installed (task 808). For the exemplary embodiment described here, task 808 confirms the presence or absence of the terminal between the threaded fastener and the contact surface of the mounting post. As explained above with reference to FIG. 4 and FIG. 9, the measured torque data can be compared against at least one predefined torque profile to determine whether or not the terminal has been properly installed. For example, the process 800 can analyze the obtained torque data to determine whether it exhibits the characteristic rise (see FIG. 9) that is associated with the compression of the deformable feature. Alternatively or additionally, the process 800 can analyze the obtained torque data to determine whether it exhibits a characteristic spike (see FIG. 4), which may be caused by a missing terminal, a stripped mounting post, or a stripped fastener. Notably, the shape, size, and mechanical properties of the deformable feature can be designed such that the torque pattern resulting from a properly installed terminal can be easily and reliably distinguished.

If the process 800 determines that the electrical terminal was properly installed (the “Yes” branch of query task 810), then it proceeds by generating an output that indicates proper installation of the terminal (task 812). The output can be provided in any suitable format, such as a displayed or printed report, chart, graph, message, alert, or the like. As another example, the output can be associated with the activation of an indicator light or sound. In some implementations, task 812 can be optional such that no action is taken and no output is generated in response to a proper and successful installation.

If, however, the process 800 determines that the electrical terminal was not properly installed (the “No” branch of query task 810), then it continues by generating an output that indicates a potentially improper installation of the terminal (task 814). As explained above, task 814 can be performed when the measured torque data is inconsistent with an expected torque profile that corresponds to a properly installed terminal. The output generated at task 814 can be provided in any suitable format, such as a displayed or printed report, chart, graph, message, alert, or the like. For example, the process 800 can generate an alarm or alert message (task 816) when the measured torque data is inconsistent with the expected torque profile. In some situations, the process 800 halts the assembly process (task 818) if it determines that the electrical terminal was not properly installed. Halting the assembly process may be desirable in certain situations to allow inspection of the electrical terminal, mounting post, and/or fastener before continuing the assembly of the particular system, device, vehicle, or product. In this regard, task 818 can be automatically initiated by the process 800 or it can be executed by a human operator.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A terminal for an electrical conductor, the terminal comprising:
a primary base structure formed of an electrically conductive material, the primary base structure comprising a coupling feature to receive a mounting post; and
a deformable feature extending above the primary base structure and compressible in response to installation of a fastener that clamps the terminal between a shoulder of the mounting post and the fastener, the deformable feature having mechanical properties and characteristics such that force required to compress the deformable feature varies as a function of height of the deformable feature.

2. The terminal of claim 1, wherein the deformable feature comprises a tab integrally formed in the primary base structure.

3. The terminal of claim 1, wherein the deformable feature comprises texturing integrally formed in the primary base structure.

4. The terminal of claim 1, wherein the deformable feature comprises a bendable element of the primary base structure.

5. The terminal of claim 1, wherein the primary base structure comprises an eyelet structure.

6. The terminal of claim 1, wherein the primary base structure comprises a prong or spade structure.

7. The terminal of claim 1, wherein the deformable feature has mechanical properties and characteristics such that force required to compress the deformable feature increases as height of the deformable feature decreases.

8. The terminal of claim 1, wherein force required to compress the deformable feature is applied by threading the fastener onto the mounting post.

9. An electrical assembly comprising:
an electrically conductive threaded mounting post comprising a contact surface;
a threaded fastener that mates with the threaded mounting post; and
a terminal for an electrical conductor, the terminal comprising a deformable feature that compresses when the threaded fastener is installed to clamp the terminal between the contact surface and the threaded fastener, the deformable feature having mechanical properties and characteristics such that torque required to compress the deformable feature increases during installation of the threaded fastener.

10. The electrical assembly of claim 9, wherein the deformable feature comprises a tab that extends above a primary contact surface of the terminal.

11. The electrical assembly of claim 9, wherein the deformable feature comprises textured features that extend above a primary contact surface of the terminal.

12. The electrical assembly of claim 9, wherein the terminal comprises a primary contact surface that is contoured to exhibit deformable characteristics.

13. The electrical assembly of claim 9, wherein the terminal comprises an eyelet structure.

14. The electrical assembly of claim 9, wherein the terminal comprises a prong or spade structure.

15. The electrical assembly of claim 9, further comprising a torque measurement tool coupled to the threaded fastener during installation of the threaded fastener onto the threaded mounting post, wherein output of the torque measurement tool indicates whether or not the terminal is present between the contact surface and the fastener during installation of the threaded fastener onto the threaded mounting post.

16. A method of checking an installation of a terminal for an electrical conductor on an electrically conductive threaded mounting post having a contact surface for the terminal, the method comprising:
coupling the terminal to the threaded mounting post, the terminal comprising a deformable feature that compresses when a threaded fastener is installed to clamp the terminal between the contact surface and the threaded fastener, the deformable feature having mechanical properties and characteristics such that torque required to tighten the threaded fastener increases as the deformable feature compresses;
installing the threaded fastener onto the threaded mounting post and overlying the terminal;
measuring, with a computer-based torque measurement tool, torque associated with installation of the threaded fastener onto the threaded mounting post until a final torque value is reached, the final torque value representing a tightened state; and
analyzing, with the computer-based torque measurement tool, the measured torque to confirm presence of the terminal between the threaded fastener and the contact surface.

17. The method of claim 16, wherein the analyzing comprises:
comparing the measured torque against a torque profile.

18. The method of claim 17, further comprising:
generating an output that indicates proper installation when the measured torque is consistent with the torque profile; and
generating an output that indicates potentially improper installation when the measured torque is inconsistent with the torque profile.

19. The method of claim 17, further comprising:
generating an alarm when the measured torque is inconsistent with the torque profile.

20. The method of claim 16, wherein installing the threaded fastener onto the threaded mounting post destructively deforms the terminal.
